(19) United States
(12) Patent Application Publication
(10) Pub. No.: US 2007/0070057 A1
(43) Pub. Date: Mar. 29, 2007

(54) Display device and method for controlling a display device

(75) Inventors: Hughes Sanoner, Hong Kong SAR (CN); Desmond Wai Nang Tse, Hong Kong SAR (CN); Ronald Tak Yan Yim, Hong Kong SAR (CN)

Correspondence Address: LEYDIG VOIT & MAYER, LTD, 700 THIRTEENTH ST. NW, SUITE 300, WASHINGTON, DC, 20005-3960, US

(73) Assignee: Solar Wide Industrial Ltd., Tsuen Wan (HK)

(21) Appl. No.: 11/226,443

(22) Filed: Sep. 15, 2005

Related U.S. Application Data
(60) Provisional application No. 60/715,600, filed on Sep. 12, 2005.

(51) Int. Cl. G09G 5/00

(52) U.S. Cl. 345/211

(57) ABSTRACT

A display device for the display of information in an environment where the intensity of ambient light varies between high and low levels has a variably intensity light source for illuminating the display and a controller for controlling intensity of the light source automatically in response to a sensed intensity of ambient light energy. The intensity of the light source is controlled between off, low and high values with the light source being off when the intensity of the ambient light is near a high value, low when the intensity of the ambient light is near a low value, and high when the intensity of the ambient light is between the high and low values.

### BACKGROUND OF THE INVENTION

1. Field of the Invention

The current invention relates to a display device and method for controlling a display device.

2. Description of Prior Art

Liquid crystal display (LCD) and similar display technologies are commonplace and used in everything from alarm clocks and mobile telephones to computer monitors and televisions. In order to improve contrast for viewing such displays a backlight is provided to help illuminate the display. The backlight adds considerable power consumption to the LCD, or other type of display, and this can be a significant problem especially in portable batteries operated devices.

### SUMMARY OF THE INVENTION

It is an object of the present invention to provide a display device and a method for controlling a display device which overcomes or at least ameliorates the above-mentioned problem, or at least provides the public with a useful alternative.

According to a first aspect of the invention there is provided a solar powered display device for the display of information in an environment where intensity of ambient light varies between high and low levels, comprising a housing, a rechargeable power source positioned within the housing, a solar cell provided with the housing for converting ambient light energy into electrical power for recharging the rechargeable power source, a display provided with the housing to display information for a user, a variably intensity light source powered by the rechargeable power source for illuminating the display, a controller for controlling intensity of the light source automatically between off, low and high values in response to a sensed intensity of the ambient light energy such that the light source is off when the intensity of the ambient light is near a high value, low when the intensity of the ambient light is near a low value, and high when the intensity of the ambient light is between the high and low values.

Preferably, the controller also controls the intensity of the light source in response to a state of charge of the rechargeable power source such that the light source is off when the state of charge of the rechargeable power source is low.

Preferably, the device includes a removable non-rechargeable power source provided in the housing for powering the device when the rechargeable power source is unable to power the device.

Preferably, the solar cell is pivotally mounted with the housing for orientation to face the source of the ambient light energy.

Preferably, the housing is weatherproof and includes a stake for locating the device in an outdoors location.

Preferably, the device includes a sensor element for sensing environmental information to display for the user, the environmental information selected from temperature, humidity and atmospheric pressure.

Preferably, the display displays weather information for a user.

According to a second aspect of the invention there is provided a method of operating a display device in an environment where intensity of ambient light varies between high and low levels, the display device having a variably intensity light source for illuminating the display and a controller for controlling intensity of the light source automatically in response to a sensed intensity of the ambient light energy, the method including controlling the intensity of the light source between off, low and high values such that the light source is off when the intensity of the ambient light is near a high value, low when the intensity of the ambient light is near a low value, and high when the intensity of the ambient light is between the high and low values.

Further aspects of the invention will become apparent from the following drawings and description.

### BRIEF DESCRIPTION OF THE DRAWINGS

Embodiments of the invention will now be described by way of example only and with reference to the accompanying drawings in which:

FIG. 1 is a side view of a solar powered display device,

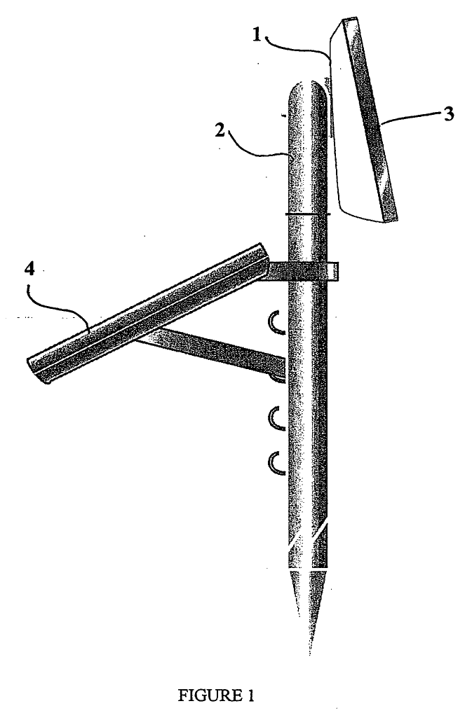

FIG. 2 is a front view of the display device, and

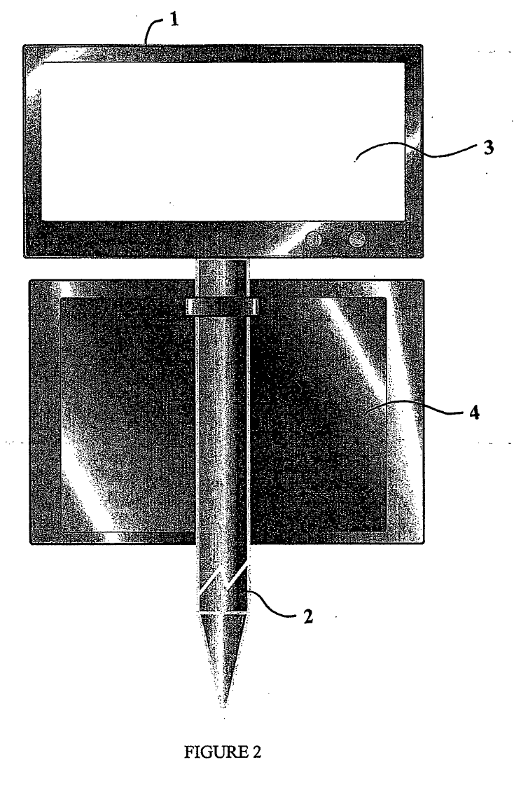

FIG. 3 is a control circuit schematic for the display device.

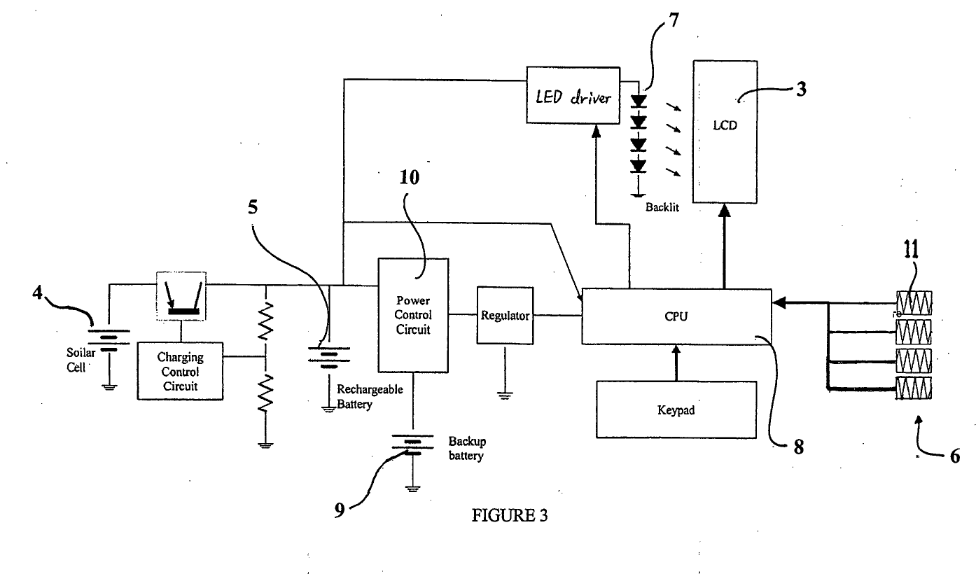

### DESCRIPTION OF THE PREFERRED EMBODIMENTS

In the drawings there is depicted a solar powered display device comprising a weatherproof housing 1 having a stake 2 for mounting the housing 1 in an outdoor location. The front of housing 1 has an LCD display 3 to display information to a user. Pivotally mounted to the stake 2 and housing 1 is a solar panel 4 of known type. The solar panel 4 can be pivotally orientated to face the sun.

Provided within the housing 1 is a rechargeable power source in the form of battery 5. Cylindrical rechargeable batteries can also be positioned within stake 2. The battery 5 powers the device via a power control circuit 10. The battery 5 is recharged by energy from the solar panel 4 via a charging control circuit.

The device has temperature, humidity and pressure sensors 6 for detecting environmental information and displaying the environmental information on display 3. A controller 8 within the housing 1 performs normal operational functions of the device, such as receiving signals from sensors 6 and indicating information the LCD display 3.

In use, the device is mounted outdoors, in a garden for example, so that a user in the outdoor location can readily read temperature, humidity, atmospheric pressure and weather forecast information on the LCD display 3. The solar panel 4 is orientated in a direction that faces direct sunlight for the greatest part of the day. The device operates 24 hours a day from the rechargeable battery 5, which is recharged during daylight hours by the solar panel 4 in known manner.

The LCD display 3 has a variable intensity backlight 7 for illuminating the display to make it easy to read. The controller 8 also controls the intensity of the backlight 7 automatically in response to a sensed intensity of the ambient light energy in the environment where the device is located. In the current embodiment the controller uses a light sensor 11, such as light dependent resistor, to determine the ambient light energy intensity. In alternative embodiments the output of solar panel 4 may be used.

In order to maximise the contrast on LCD display 3 for easy reading while at the same time minimizing energy use by the backlight 7 the controller controls the backlight between off, low intensity and high intensity values depending on the intensity of the ambient light energy. In the middle of the day when the ambient light energy is high the controller turns off the backlight. At night-time when the ambient light energy is low the controller turns on the backlight 7 with a low illumination intensity. During night-time low intensity of the backlight conserves energy when the rechargeable battery 5 is not being charged while still providing sufficient contrast for easy reading of the display 3 by the user. In the morning and late afternoon/evening when ambient light levels are at their intermediate value the LCD display 3 may be difficult to read. At this time the controller controls the intensity of backlight 7 to a high value to maximise contrast of LCD display 3 for easy reading by the user.

During winter months or periods of prolonged bad weather the daytime ambient light energy may not reach significantly high values. During this time there is a risk that the solar panel 4 cannot supply enough energy to fully recharged battery 5. To ameliorate this risk the device is provided with a non-rechargeable replaceable battery 9 connected to the power control circuit 10. If the state of charge of the rechargeable battery 5 falls to a level where it cannot continue to power the device then the power control circuit 10 maintains power to the device from the backup battery 9.

The embodiment described is a solar powered display device, however the method of controlling the backlight of the display device for the purpose of maximizing contrast of the display while minimising energy use is applicable to other types of backlit display. The method may be used in battery powered devices using backlit displays such as mobile telephones, PDAs and MP3 players. The method may also find application in mains-power devices which utilised backlit displays such as LCD clocks, weather stations, LCD computer monitors and LCD/Plasma TVs. In such mains-power devices there is still a need to minimise energy use for environmental reasons. The average energy reduction through use of the method in one device such as a computer monitor or LCD/Plasma TV may not be significant but when multiplied over the life of the device and by the very significant number of such devices in use in the world the potential energy savings are considerable.

Where in the foregoing description reference has been made to integers or elements having known equivalents then such are included as if individually set forth herein.

Embodiments of the invention have been described, however it is understood that variations, improvement or modifications can take place without departure from the scope of the appended claims.

1. A solar powered display device for the display of information in an environment where intensity of ambient light varies between high and low levels, comprising:
a housing,
a rechargeable power source positioned within the housing,
a solar cell provided with the housing for converting ambient light energy into electrical power for recharging the rechargeable power source,
a display provided with the housing for displaying information to a user,
a variable intensity light source powered by the rechargeable power source for illuminating the display, and
a controller for controlling intensity of the light source automatically between off, low, and high values in response to sensed intensity of the ambient light energy such that the light source is (i) off when the intensity of the ambient light is near a high value, (ii) low when the intensity of the ambient light is near a low value, and (iii) high when the intensity of the ambient light is between the high and low values.

2. The device of claim 1 wherein the controller controls the intensity of the light source in response to state of charge of the rechargeable power source such that the light source is off when the state of charge of the rechargeable power source is low.

3. The device of claim 1 further including a removable non-rechargeable power source provided in the housing for powering the device when the rechargeable power source is unable to power the device.

4. The device of claim 1 wherein the solar cell is pivotally mounted with the housing for orientation to face a source of the ambient light energy.

5. The device of claim 1 wherein the housing is weatherproof and includes a stake for locating the device in an outdoors location.

6. The device of claim 1 further including a sensor element for sensing environmental information for display to the user, the environmental information being selected from temperature, humidity, and atmospheric pressure.

7. The device of claim 1 wherein the display displays weather information to a user.

8. A method of operating a display device in an environment where intensity of ambient light varies between high and low levels, the display device having a variable intensity light source for illuminating the display and a controller for controlling intensity of the light source automatically, in response to sensed intensity of the ambient light energy, the method including controlling the intensity of the light source between off, low, and high values such that the light source is (i) off when the intensity of the ambient light is near a high value, (ii) low when the intensity of the ambient light is near a low value, and (iii) high when the intensity of the ambient light is between the high and low values.
